(19) United States
(12) Patent Application Publication
(10) Pub. No.: US 2022/0222349 A1
(43) Pub. Date: Jul. 14, 2022

(54) INFORMATION HANDLING SYSTEM HOST TO MANAGEMENT CONTROLLER ATTESTATION SERVICE CHANNEL

(71) Applicant: Dell Products L.P., Round Rock, TX (US)

(72) Inventors: Timothy M. LAMBERT, Austin, TX (US); Pablo R. ARIAS, Austin, TX (US); Milton Olavo Decarvalho TAVEIRA, Round Rock, TX (US); Marshal F. SAVAGE, Austin, TX (US)

(73) Assignee: Dell Products L.P., Round Rock, TX (US)

(21) Appl. No.: 17/148,286

(22) Filed: Jan. 13, 2021

(51) Int. Cl. G06F 21/57; G06F 21/54; G06F 21/85; G06F 13/24; G06F 13/42

(52) U.S. Cl. CPC G06F 21/575; G06F 21/54; G06F 2221/0751; G06F 13/24; G06F 13/4282; G06F 21/85

(57) ABSTRACT

An information handling system may include a host system comprising a processor and a management controller comprising a main processor and a trusted integrated processor configured to perform secured boot services and run-time security functions of the management controller. The information handling system may also include a legacy communications bus interfaced between the host system and the main processor and a secure communications bus interfaced between the host system and the main processor. The trusted integrated processor is further configured to implement a secure attestation channel to the host system via the secure communications bus in order to provide access by the host system to security services owned by the management controller.

### TECHNICAL FIELD

The present disclosure relates in general to information handling systems, and more particularly to methods and systems for implementing a host to management controller attestation service channel in an information handling system.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

In next-generation management controllers, it is envisioned that a management controller may include a main processor, as in traditional approaches, plus a trusted integrated processor configured to provide secured boot services and run-time security functions such as signature services, root of trust, external monitoring of a serial peripheral interface, secure handling of keys, and other functionality. For a host-side application of service such as a basic input/output system, a service administrator, or other application, to access such services through traditional host-to-management controller interfaces may require the domain of the main processor of the management controller to be up and running in order to be trusted.

However, if during runtime validation, the trusted integrated processor found evidence of tampering and/or unmatched firmware version hashes, it may hold the main processor in reset for security reasons. With the main processor in reset, the host would not be able to make a determination of why the main processor of the management controller is not available and the reasons for failed verification.

### SUMMARY

In accordance with the teachings of the present disclosure, the disadvantages and problems associated with existing approaches to management controller attestation may be reduced or eliminated.

In accordance with embodiments of the present disclosure, an information handling system may include a host system comprising a processor and a management controller comprising a main processor and a trusted integrated processor configured to perform secured boot services and run-time security functions of the management controller. The information handling system may also include a legacy communications bus interfaced between the host system and the main processor and a secure communications bus interfaced between the host system and the main processor. The trusted integrated processor is further configured to implement a secure attestation channel to the host system via the secure communications bus in order to provide access by the host system to security services owned by the management controller.

In accordance with these and other embodiments of the present disclosure, a method may be provided for an information handling system including a host system having a processor and a management controller having a main processor and a trusted integrated processor configured to perform secured boot services and run-time security functions of the management controller. The method may include implementing, by the trusted integrated processor, a secure attestation channel to the host system via a secure communications bus in order to provide access by the host system to security services owned by the management controller. The method may also include enabling, by the trusted integrated processor, the host system to bypass the main processor of the management controller to obtain information regarding security services performed by the management controller.

In accordance with these and other embodiments of the present disclosure, an article of manufacture may include a non-transitory computer-readable medium and computer-executable instructions carried on the computer-readable medium, the instructions readable by a processing device, the instructions, when read and executed, for causing the processing device to, in an information handling system including a host system having a processor and a management controller having a main processor and a trusted a trusted integrated processor configured to perform secured boot services and run-time security functions of the management controller, implement, by the trusted integrated processor, a secure attestation channel to the host system via a secure communications bus in order to provide access by the host system to security services owned by the management controller.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates a flow chart of an example method for verification of memory attached to a trusted integrated processor, in accordance with embodiments of the present disclosure;

FIG. 3 illustrates a flow chart of an example method for host application request of firmware versions, in accordance with embodiments of the present disclosure; and

FIG. 4 illustrates a flow chart of an example method for a trusted integrated processor alert of failure, in accordance with embodiments of the present disclosure.

### DETAILED DESCRIPTION

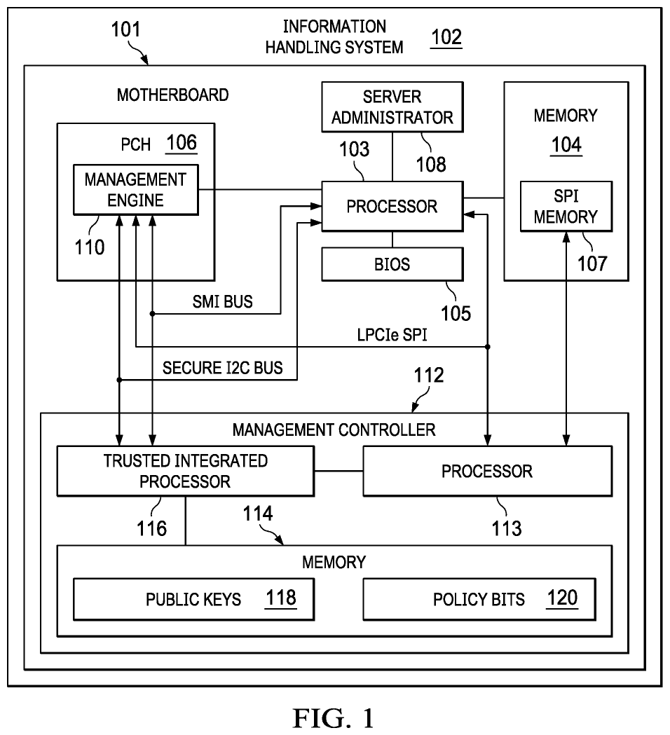

Preferred embodiments and their advantages are best understood by reference to FIGS. 1 through 4 wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a block diagram of an example information handling system 102, in accordance with embodiments of the present disclosure. In some embodiments, information handling system 102 may comprise or be an integral part of a server. In other embodiments, information handling system 102 may be a personal computer. In these and other embodiments, information handling system 102 may be a portable information handling system (e.g., a laptop, notebook, tablet, handheld, smart phone, personal digital assistant, etc.). As depicted in FIG. 1, information handling system 102 may include a motherboard 101.

Motherboard 101 may include a circuit board configured to provide structural support for one or more information handling resources of information handling system 102 and/or electrically couple one or more of such information handling resources to each other and/or to other electric or electronic components external to information handling system 102. As shown in FIG. 1, motherboard 101 may include processor 103, a memory 104 communicatively coupled to processor 103, a platform controller hub (PCH) 106 communicatively coupled to processor 103, and a management controller 112 communicatively coupled to processor 103.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off. Although memory 104 is depicted in FIG. 1 as integral to motherboard 101, in some embodiments, all or a portion of memory 104 may reside external to motherboard 101. As shown in FIG. 1, a portion of memory 104 may comprise Serial Peripheral Interface (SPI) memory 107, which may be a secured portion of memory which includes boot firmware, firmware for trusted integrated processor 116, firmware for BIOS 105, firmware for management controller 112, and/or other protected executable code. Accordingly, processor 103 may only be given read-only access to SPI memory 107, while trusted integrated processor 116 may be given full read and write access to SPI memory 107.

BIOS 105 may be communicatively coupled to processor 103 and may include any system, device, or apparatus configured to identify, test, and/or initialize information handling resources of information handling system 102. “BIOS” may broadly refer to any system, device, or apparatus configured to perform such functionality, including without limitation, a Unified Extensible Firmware Interface (UEFI). In some embodiments, BIOS 105 may be implemented as a program of instructions that may be stored on a read-only memory of information handling system 102 and which may be read by and executed on processor 103 to carry out the functionality of BIOS 105. In these and other embodiments, BIOS 105 may comprise boot firmware configured to be the first code executed by processor 103 when information handling system 102 is booted and/or powered on. As part of its initialization functionality, code for BIOS 105 may be configured to set components of information handling system 102 into a known state, so that one or more applications (e.g., an operating system or other application programs) stored on compatible media (e.g., memory 104) may be executed by processor 103 and given control of information handling system 102.

PCH 106 may be any system, device, or apparatus configured to control certain data paths (e.g., data flow between processor 103, memory 104, and peripherals) and support certain functions of processor 103. A PCH 106 may also be known as a “chipset” of an information handling system 102. One such function may include management engine 110. Management engine 110 may comprise hardware and/or firmware that enables remote out-of-band management for information handling system 102 in order to monitor, maintain, update, upgrade, and/or repair information handling system 102. In some embodiments, management engine 110 may include hardware and firmware compliant with Intel's Active Management Technology. In these and other embodiments, firmware components of management engine 110 may be stored as a part of BIOS 105 on a read-only memory of information handling system 102.

Server administrator 108 may comprise an application executable on processor 103 that implements a software agent that provides a one-to-one systems management solution to allow an administrator to manage information handling system 102 via an integrated web browser-based graphical user interface, a command line interface, and/or other means. In some embodiments, server administrator 108 may be implemented using OpenManage Server Administrator by Dell.

Together, processor 103, BIOS 105, PCH 106, server administrator 108, and other applications executing on processor 103 may be considered a “host system” for information handling system 102.

Management controller 112 may be configured to provide out-of-band management facilities for management of information handling system 102. Such management may be made by management controller 112 even if information handling system 102 is powered off or powered to a standby state. Management controller 112 may include a processor 113, memory 114 communicatively coupled to processor 113, and a trusted integrated processor 116. In certain embodiments, management controller 112 may include or may be an integral part of a baseboard management controller (BMC), a remote access controller (e.g., a Dell Remote Access Controller or Integrated Dell Remote Access Controller), or an enclosure controller. In other embodiments, management controller 112 may include or may be an integral part of a chassis management controller (CMC).

Processor 113 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 113 may interpret and/or execute program instructions and/or process data stored in memory 114 and/or another component of information handling system 102 or management controller 112.

Trusted integrated processor 116 may comprise a cryptoprocessor or special co-processor configured to provide secured boot services and run-time security functions of management controller 112, including without limitation signature services, root of trust, external monitoring of a serial peripheral interface, secure handling of keys, and other functionality. In some embodiments, trusted integrated processor 116 may include a trusted platform module or similar device configured to carry out cryptographic operations on data communicated to it from processor 113 and/or another component of management controller 112.

Memory 114 may be communicatively coupled to trusted integrated processor 116 and may include any system, device, or apparatus configured to retain program instructions and/or data for a period of time (e.g., computer-readable media). Memory 114 may include RAM, EEPROM, a PCMCIA card, flash memory, magnetic storage, opto-magnetic storage, or any suitable selection and/or array of volatile or non-volatile memory that retains data after power to management controller 112 is turned off. In particular embodiments, memory 114 may comprise a one-time programmable array which may include public keys 118 and/or policy bits 120 for use by trusted integrated processor 116 in performing its secure operations.

As shown in FIG. 1, components of the host system of information handling system 102 (e.g., processor 103 and PCH 106) may be communicatively coupled to processor 113 of management controller 112 via a low pin count (LPC)/Enhanced Serial Peripheral Interface (eSPI) communications bus, as is done in traditional approaches. However, in accordance with embodiments of the present disclosure, information handling system 102 may include a secure communications bus (e.g., an Inter-Integrated Circuit (I2C) bus) owned solely by trusted integrated processor 116 and interfaced between the host system of information handling system 102 and trusted integrated processor 116. In addition, information handling system 102 may include a system management interrupt (SMI) bus owned by trusted integrated processor 116 and interfaced between the host system of information handling system 102 and trusted integrated processor 116 to enable trusted integrated processor 116 to alert the host system of events triggered by services performed by trusted integrated processor 116.

Because the I2C bus and SMI bus are owned solely by trusted integrated processor 116, the services offered by trusted integrated processor 116 may circumvent/bypass the domain of processor 113, allowing applications of the host system to request these services or to respond to events communicated over the SMI bus. Further, communication on this channel need not be encrypted, as no host-controllable function may be capable of changing behavior of trusted integrated processor 116 and no exchange of secure secrets may be exchanged through the I2C bus.

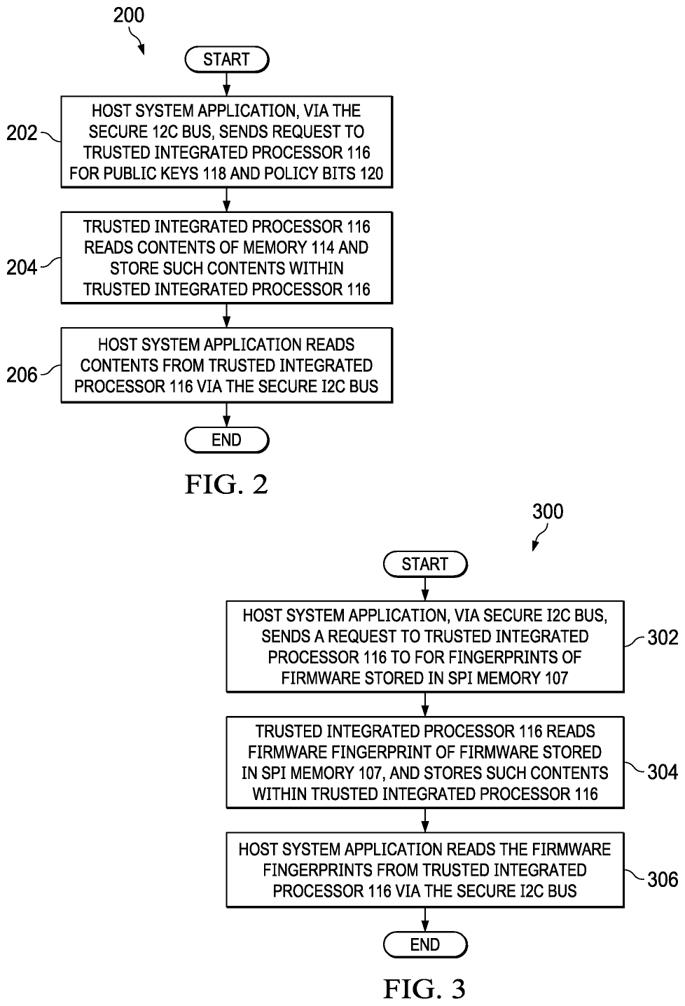

FIG. 2 illustrates a flow chart of an example method 200 for verification of memory 114 attached to trusted integrated processor 116, in accordance with embodiments of the present disclosure. According to some embodiments, method 200 may begin at step 202. As noted above, teachings of the present disclosure may be implemented in a variety of configurations of information handling system 102. As such, the preferred initialization point for method 200 and the order of the steps comprising method 200 may depend on the implementation chosen.

At step 202, a host system application (e.g., server administrator 108) may, via the secure I2C bus, send a request to trusted integrated processor 116 for public keys 118 and policy bits 120. At step 204, trusted integrated processor 116 may read contents of memory 114 and store such contents within trusted integrated processor 116 (e.g., in a random access memory internal or otherwise accessible to trusted integrated processor 116). At step 206, the host system application may read the contents from trusted integrated processor 116 via the secure I2C bus.

Although FIG. 2 discloses a particular number of steps to be taken with respect to method 200, method 200 may be executed with greater or fewer steps than those depicted in FIG. 2. In addition, although FIG. 2 discloses a certain order of steps to be taken with respect to method 200, the steps comprising method 200 may be completed in any suitable order.

Method 200 may be implemented using information handling system 102 or any other system operable to implement method 200. In certain embodiments, method 200 may be implemented partially or fully in software and/or firmware embodied in computer-readable media.

FIG. 3 illustrates a flow chart of an example method 300 for host application request of firmware versions, in accordance with embodiments of the present disclosure. According to some embodiments, method 300 may begin at step 302. As noted above, teachings of the present disclosure may be implemented in a variety of configurations of information handling system 102. As such, the preferred initialization point for method 300 and the order of the steps comprising method 300 may depend on the implementation chosen.

At step 302, a host system application (e.g., server administrator 108) may, via the secure I2C bus, send a request to trusted integrated processor 116 for fingerprints (e.g., hashes) of firmware stored in SPI memory 107. At step 304, trusted integrated processor 116 read firmware fingerprint of firmware stored in SPI memory 107, and store such contents within trusted integrated processor 116 (e.g., in a random access memory internal or otherwise accessible to trusted integrated processor 116). At step 306, the host system application may read the firmware fingerprints from trusted integrated processor 116 via the secure I2C bus. With such information, the host system application may perform measurements of boot firmware or other executable code, for diagnostic or other purposes.

Although FIG. 3 discloses a particular number of steps to be taken with respect to method 300, method 300 may be executed with greater or fewer steps than those depicted in FIG. 3. In addition, although FIG. 3 discloses a certain order of steps to be taken with respect to method 300, the steps comprising method 300 may be completed in any suitable order.

Method 300 may be implemented using information handling system 102 or any other system operable to implement method 300. In certain embodiments, method 300 may be implemented partially or fully in software and/or firmware embodied in computer-readable media.

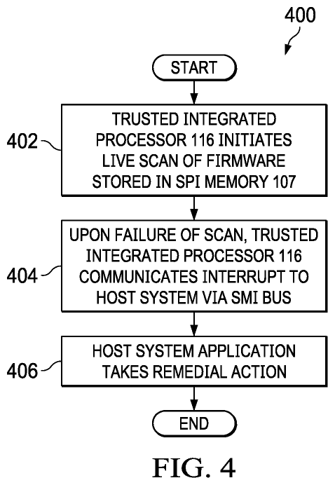

FIG. 4 illustrates a flow chart of an example method 400 for a trusted integrated processor alert of failure, in accordance with embodiments of the present disclosure. According to some embodiments, method 400 may begin at step 402. As noted above, teachings of the present disclosure may be implemented in a variety of configurations of information handling system 102. As such, the preferred initialization point for method 400 and the order of the steps comprising method 400 may depend on the implementation chosen.

At step 402, trusted integrated processor 116 may initiate a live scan of firmware stored in SPI memory 107. At step 404, upon failure of a scan, trusted integrated processor 116 may communicate an interrupt to the host system via the SMI bus. In response, at step 406, a host system application (e.g., server administrator 108) may take a remedial action (e.g., log, issue notification, shutdown information handling system 102, etc.).

Although FIG. 4 discloses a particular number of steps to be taken with respect to method 400, method 400 may be executed with greater or fewer steps than those depicted in FIG. 4. In addition, although FIG. 4 discloses a certain order of steps to be taken with respect to method 400, the steps comprising method 400 may be completed in any suitable order.

Method 400 may be implemented using information handling system 102 or any other system operable to implement method 400. In certain embodiments, method 400 may be implemented partially or fully in software and/or firmware embodied in computer-readable media.

The attestation service channel described above may also enable other advantages. For example, the systems and methods described above may enable a host system to request, via the secure I2C channel, an inventory of all firmware on SPI memory 107. As another example, the systems and methods described above may enable a host system to perform diagnostics and debugging in the event of authentication failures and/or failures in the boot process of management controller 112. As a further example, the systems and methods described above may enable trusted integrated processor 116 to signal to a host system an occurrence of recovery attempts, a boot header not being found at an expected location, and/or other events.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described above, the principles of the present disclosure may be implemented using any number of techniques, whether currently known or not. The present disclosure should in no way be limited to the exemplary implementations and techniques illustrated in the figures and described above.

Unless otherwise specifically noted, articles depicted in the figures are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. An information handling system comprising:
a host system comprising a processor;
a management controller comprising:
a main processor; and
a trusted integrated processor configured to perform secured boot services and run-time security functions of the management controller;
a legacy communications bus interfaced between the host system and the main processor; and
a secure communications bus interfaced between the host system and the main processor;
wherein the trusted integrated processor is further configured to implement a secure attestation channel to the host system via the secure communications bus in order to provide access by the host system to security services owned by the management controller.

2. The information handling system of claim 1, wherein the secure communications bus comprises an Inter-Integrated Circuit bus.

3. The information handling system of claim 1, wherein the security services owned by the management controller comprise one or more public keys stored in a memory accessible to the trusted integrated processor.

4. The information handling system of claim 1, wherein the security services owned by the management controller comprise one or more security policy settings stored in a memory accessible to the trusted integrated processor.

5. The information handling system of claim 1, wherein the security services owned by the management controller comprise boot firmware for one or more components of the information handling system.

6. The information handling system of claim 1, further comprising a system management interrupt bus interfaced between the trusted integrated processor and the host system, and wherein the trusted integrated processor is configured to communicate an alert to the host system via the system management interrupt bus in response to a security service performed by the management controller.

7. The information handling system of claim 1, wherein the trusted integrated processor enables the host system to bypass the main processor of the management controller to obtain information regarding security services performed by the management controller.

8. A method comprising, in an information handling system including a host system having a processor and a management controller having a main processor and a trusted integrated processor configured to perform secured boot services and run-time security functions of the management controller:
implementing, by the trusted integrated processor, a secure attestation channel to the host system via a secure communications bus in order to provide access by the host system to security services owned by the management controller; and
enabling, by the trusted integrated processor, the host system to bypass the main processor of the management controller to obtain information regarding security services performed by the management controller.

9. The method of claim 9, wherein the secure communications bus comprises an Inter-Integrated Circuit bus.

10. The method of claim 9, wherein the security services owned by the management controller comprise one or more public keys stored in a memory accessible to the trusted integrated processor.

11. The method of claim 9, wherein the security services owned by the management controller comprise one or more security policy settings stored in a memory accessible to the trusted integrated processor.

12. The method of claim 9, wherein the security services owned by the management controller comprise boot firmware for one or more components of the information handling system.

13. The method of claim 9, further comprising communicating an alert to the host system via the system management interrupt bus in response to a security service performed by the management controller, the alert communicated via a system management interrupt bus interfaced between the trusted integrated processor and the host system.

14. An article of manufacture comprising:
a non-transitory computer-readable medium; and
computer-executable instructions carried on the computer-readable medium, the instructions readable by a processing device, the instructions, when read and executed, for causing the processing device to, in an information handling system including a host system having a processor and a management controller having a main processor and a trusted a trusted integrated processor configured to perform secured boot services and run-time security functions of the management controller:
implement, by the trusted integrated processor, a secure attestation channel to the host system via a secure communications bus in order to provide access by the host system to security services owned by the management controller.

15. The article of claim 14, wherein the secure communications bus comprises an Inter-Integrated Circuit bus.

16. The article of claim 14, wherein the security services owned by the management controller comprise one or more public keys stored in a memory accessible to the trusted integrated processor.

17. The article of claim 14, wherein the security services owned by the management controller comprise one or more security policy settings stored in a memory accessible to the trusted integrated processor.

18. The article of claim 14, wherein the security services owned by the management controller comprise boot firmware for one or more components of the information handling system.

19. The article of claim 14, further comprising communicating an alert to the host system via the system management interrupt bus in response to a security service performed by the management controller, the alert communicated via a system management interrupt bus interfaced between the trusted integrated processor and the host system.

20. The article of claim 14, the instructions for further causing the processor to enable, by the trusted integrated processor, the host system to bypass the main processor of the management controller to obtain information regarding security services performed by the management controller.
